(19) United States
(12) Patent Application Publication
(10) Pub. No.: US 2005/0139012 A1
(43) Pub. Date: Jun. 30, 2005

(54) Method and apparatus for sensing

(76) Inventors: Ilkka Suorsa, Espoo (FI); Juhani Tellinen, Espoo (FI)

Correspondence Address: SHOEMAKER AND MATTARE, LTD, 10 POST OFFICE ROAD - SUITE 110, SILVER SPRING, MD, 20910, US

(21) Appl. No.: 10/507,762

(22) PCT Filed: Mar. 17, 2003
(86) PCT No.: PCT/FI03/00201

(30) Foreign Application Priority Data
Mar. 15, 2002 (FI) 20020496
Mar. 3, 2003 (FI) 20030333

(51) Int. Cl. G01L 1/00

(52) U.S. Cl. 73/779

(57) ABSTRACT

The present invention relates to a method for sensing electrical or magnetic and the like parameters and for utilizing the same, comprising taking a piece of material with stress-influenced parameters based on structural changes; directing on the material forces which effect a shape change on it; measuring the change in magnetic, electrical or the like parameters of the piece of material; and using the measured parameters for controlling further operations. The invention also relates to apparatus for this purpose.

### FIELD OF THE INVENTION

The present invention relates to a new way of sensing position, velocity and/or acceleration based on materials with stress-influenced parameters based on structural changes (SIPBSC). The SIPBSC materials can be used for different types of sensor applications: one, two or three dimensional sensors, torsion sensors and/or bending sensors or a combination of them.

### BACKGROUND OF THE INVENTION

In applications of mechanical engineering position, acceleration and velocity are important parameters, which are often necessary to be monitored. Many kinds of methods and materials are used today to measure those parameters, such as strain gauges, optical laser sensors and tachometers using permanent magnets. Use of sensors has recently increased in several industrial products, such as automobiles and machines. Sensors have been applied to new fields, such as automobile airbag systems, in which, e.g., silicon-based acceleration sensors are used today.

### SUMMARY OF THE INVENTION

The variable parameters of SIPBSC materials can be magnetic or electrical parameters (such as resistance) of a SIPBSC element. We have discovered that the properties of SIPBSC materials can be used for sensing mechanical properties like position, velocity or acceleration (stress). The SIPBSC element can act as a sensor in the case of one, two or three dimensional sensors measuring linear motion, bending or torsion or a combination of them. Because of the inverse effect the materials can be used to monitor magnetic field or other properties related to the magnetic field. Examples of SIPBSC materials are ferromagnetic shape memory alloys (FSMA). such as Heusler alloys, especially Ni—Mn—Ga and Ni—Mn—Ga based alloys. It is emphasized that FSMA means in this presentation shape memory alloys that are ferromagnetic. Dimensions of these materials do not need to be controlled by a magnetic field like in materials that in the literature are called FSMAs or magnetically controlled shape memory (MSM) alloys. FSMAs have specific structure and magnetic properties. When FSMAs are mechanically deformed their twin structure, or phase structure, is changed; namely twin variants or/and martensite variants in preferential orientation to stress grow and the other variant(s) shrink, thus leading to changes in certain magnetic properties described below. Changes of the magnetic or electrical properties, such as permeability, reluctance, magnetization or electrical resistance, due to deformation are utilized in monitoring position, velocity or/and acceleration.

Purpose of the invention is to achieve a method and apparatus for sensing position, velocity and/or acceleration based on monitoring certain magnetic or electrical parameters influenced by shape changes of the piece of a SIPBSC material. This invention makes it possible to make sensing in a versatile and economical way in various applications, such as machines, engines, constructions, vehicles or aircrafts. This has been achieved in a way characterized in accompanied claims.

### BRIEF DESCRIPTION OF THE DRAWINGS

FIG. 1a shows schematic view of the magnetization curves of SIPBSC materials.

FIG. 1b shows compressive stress vs. strain curves of two Ni—Mn—Ga alloys, named alloys A and B, and schematic pictures of the pieces of alloy A after deforming the pieces ε=0. 3 and 6%.

FIG. 2 shows two extreme points of operation when the sample is pressed and pulled up and down in the air-gap of the inductor.

FIG. 3 shows the schematic view of the cross-section of the studied system

FIG. 4 shows inductance-position curve of the magnetic field.

FIG. 5 shows dependence of inductance on temperature.

FIG. 6 shows measurement system in the resistance-strain measurement.

FIG. 7 shows the measured resistance of the FSMA element as a function of strain.

FIG. 8 shows simple schematic view of the joystick.

FIG. 9 shows dimensions of the first joystick solution.

FIG. 10 shows signal voltages from field sensors in both directions when the stick is bent in x direction.

FIG. 11 shows hysteresis loops of the first joystick solution.

FIG. 12 shows exact dimensions of the second explained joystick solution.

FIG. 13 shows signal voltages in different directions when the stick is bent in x direction.

FIG. 14 shows signal voltages from magnetic field sensors in different directions when the stick is bent in y direction.

FIG. 15 shows schematic view of twin variants (bands in the martensite phase) in the studied FSMA stick.

FIG. 16 shows twin variants in the FSMA material in positive x-direction when the stick is not bent.

FIG. 17 shows twin variants in the FSMA material in positive x-direction when material is bent in positive y-direction.

FIG. 18 shows twin variants in the FSMA material in positive x-direction when material is bent in negative y-direction.

FIG. 19 shows twin variants in the FSMA material in positive y-direction when material is not bent.

FIG. 20 shows twin variants in the FSMA material in positive y-direction when material is bent.

FIG. 21 shows the measured peak induced voltage as a function of the peak velocity.

FIG. 22 shows an example stress-strain curve of the FSMA element to be used as an acceleration sensor.

FIG. 23 shows a simplified equivalent circuit of the FSMA device for power generation.

FIG. 24 shows graphical presentation of the magnetic circuit equations for the FSMA device at descending φ_{c}.

FIG. 25 shows an operation circle of the FSMA device.

FIG. 26 shows magnetisation curves of the FSMA material (Ni—Mn—Ga).

FIG. 27 shows a test diagram of the electric energy generation by an FSMA device.

FIG. 28 shows transient terminal voltage of the FSMA device at load resistance of 1 Ohm (FSMA stick is compressed and expanded).

FIG. 29 shows the measurement set-up in first example.

FIG. 30 shows measured results in the first example.

FIG. 31 shows the measurement set-up in the second example.

FIG. 32 shows measured results in the second example.

### DETAILED DESCRIPTION OF THE INVENTION

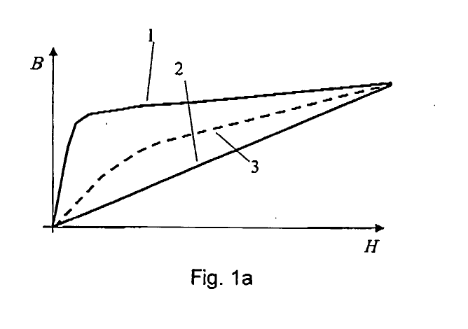

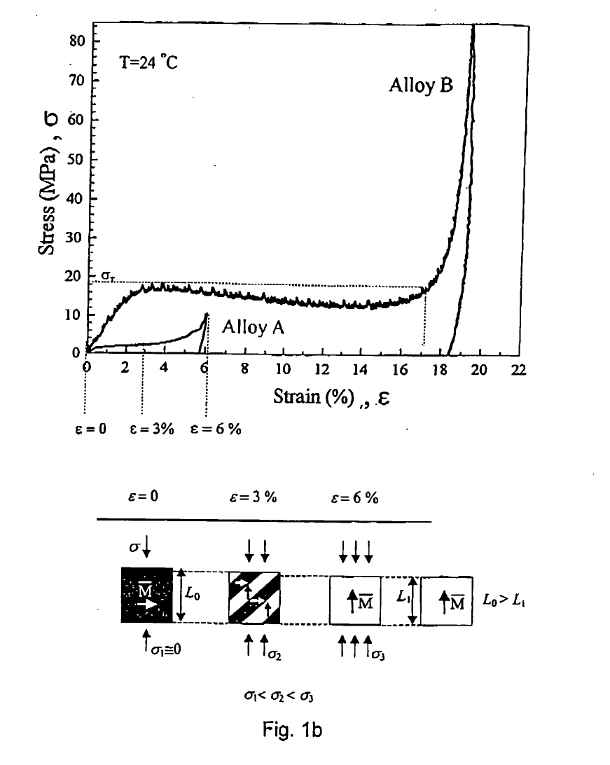

This invention considers the phenomena and applications of materials with stress-influenced magnetization based on structural changes (SIPBSC). In all SIPBSC materials the magnetization curve and/or electrical properties, like resistance, depend on the shape of the piece of the material, also called SIPBSC element in this presentation. The SIPBSC effect is based on the changing proportions of internal areas of the material. These areas differ from each other by their magnetization curves (in the case of electrical resistance, however, changes in the magnetization curves are not necessary). The global actual magnetization curve of the material is a function of the proportions of the different areas. The proportions of the internal areas in turn can be changed by applying the magnetic field or stress to the piece of the material resulting in a shape change of the piece of material. Therefore, the applied magnetic field or stress and the dimensions of the piece of the material are connected to the actual magnetization curve of the SIPBSC materials. FIG. 1a shows a schematic view of the magnetization curves of 3 certain Ni—Mn—Ga alloy whose short axis of its tetragonal lattice is an easy direction of magnetization. In this Figure curve 1 corresponds to an area (of the piece of material) of easy magnetization when the length of the piece is x=xₘₐₓ, curve 2 corresponds to the area of hard magnetization when x=xₘᵢₙ and curve 3 is an actual magnetization curve when the length of the stick is x (xₘᵢₙ<x<xₘₐₓ).

There are three different mechanisms how SIPBSC materials can produce shape changes under stress or a magnetic field:
1. Changes of twin variants. This SIPBSC material consists of (one, two or more) variants, which have anisotropy in magnetization. These variants are in different orientation in relation to each other. The change in the proportions of the variants induced by stress or a magnetic field cause change in the magnetization curve in a specific direction and in the shape of the piece of the material. This feature makes it a SIPBSC material. Ferromagnetic shape memory (FSMA) materials are one group of these kinds of materials.

FIG. 1b shows two examples of such FSMA materials. This figure shows compressive stress vs. strain curves of two different Ni—Mn—Ga alloys. One alloy marked by A can be compressed up to 6% at very low load levels, only a few MPa. The unit cell of the lattice of this Ni—Mn—Ga martensite phase is tetragonal, and its short axis (c axis) is about 6% shorter than the other axes a and b. Easy direction of magnetization is parallel to c axis. The piece of material A shown in FIG. 1b is initially (ε=0) composed of only one variant (marked as black area) whose c axis (and easy direction of magnetization M) is perpendicular to the direction of the stress. When the compressive stress is applied, second variant having its c axis orientation parallel to the stress direction appears and starts growing when stress is increased. FIG. 1b shows a schematic picture of the piece of the material when the piece is contracted 3% (ε=3%) by a stress of σ₂. About half of the material volume is now composed of the second variant (marked grey). At a certain stress level σ₃ the piece of the material is fully compressed (ε=6%) and is composed only of the second variant whose easy direction of magnetization and c axis direction are parallel to the stress direction. The maximal compression ε=6% corresponds to the axial ratio c/a of the unit cell.

Nothing happens in the shape of the piece of the material when the stress is removed, because there is no restoring force in the material. This makes the material mechanically stable at any position, which is of great importance in sensor applications. If the stress would then be applied in the c direction of the second variant the original situation (ε=0) would be recovered. In material A also magnetic field in stead of or in addition to stress also changes the shape of the piece of the material in the same way as shown for stress in FIG. 1b. We have strained the pieces of the materials from one variant state to the other over 200 million times without any detectable changes in the material properties. This proves that it is possible to make very durable sensors from SIPBSC materials.

In alloy B maximal strain that is possible to achieve by stress based on converting one variant to the other is nearly 20%. This Ni—Mn—Ga composition exhibits a tetragonal lattice whose c axis is about 20% larger than a and b axes. In this material compressive stress favours short lattice direction and tensile stress favours long c axis direction. Easy plane of magnetization is an a-b plane. Magnetocrystalline anisotropy energy of this material is significantly higher than that of alloy A. One feature in alloy B is that when a certain threshold stress σᵣ is achieved, the piece of the material strains up to 17% with the same stress. This feature is applied, e.g., in certain accelerations sensors described below.
2. Change in stacking of atoms. Different lattice structures have different magnetization curves and geometric dimensions. Materials in which stacking of its atoms occur can be used as SIPBSC materials. For example in certain Co—Ni alloys (e.g., Co—32Ni) lattice structure changes from FCC (face centered cubic) to HCP (hexagonal close-packed) or vice verse when stress or a magnetic field is applied on a piece of such material thus leading to shape changes of the piece.
3 Changes in martensite variants. Austenite and martensite phases have different magnetization curves and dimensions. When stress is applied to the piece of such material proportions of the austenite and martensite phases change, especially those martensite variants (i.e., certain cystallographically oriented areas) that are in a favourable orientation in relation to the stress grow and other variants shrink thus leading to shape changes of the piece of the material. This kind of material can be used as SIPBSC material.

The relation between magnetization curve, resistance and the position and stress of SIPBSC materials can be used in many ways. Basic applications are for example position measurement based on permeability change or electric energy production with mechanical energy. There are also other applications. For example the magnetization curve of the SIPBSC material has changing hysteresis with different remanence flux and coercive field strength. Therefore, it can also be used as adjustable permanent magnet. Another example is the measurement of the speed of shape change of a piece of SIPBSC material based on Faraday's law.

The SIPBSC materials have excellent properties for sensors because the materials are mechanically stable, they have high damping capacity, they have demonstrated long fatigue life (over 200 million cycles without fatigue) and they can bear high loads (up to 800 MPa has been measured). Mechanical stability means, for instance, that the piece of an SIPBSC material remains unchanged at every position if the affecting force is removed, because normally there is no restoring force in the material. However, if the materials are used at temperatures of so-called superelastic region, then restoring force appears. These temperatures are above normal operation temperatures of SIPBSC materials. High vibration damping capacity of the SIPBSC materials due to stress-induced motion of twin boundaries or/and martensite interfaces makes SIPBSC sensors rather insensitive to vibrations. This feature can also be applied in SIPBSC vibration dampers. Operation temperature range of may SIPBSC materials is wide, e.g., alloy B shown in FIG. 1a works from below 100 K to over 750 K it is also possible to make very small pieces of the SIPBSC materials in order to make small sensors. SIPBSC materials can be deposited on a suitable substrate and can be formed to sensor elements using. e.g., etching, laser cutting or micromachining methods.

If not otherwise specified, the word sensor means position, velocity or/and acceleration sensor in the following description.

In the following examples the invention is described as a matter of example only, and it is not taken as to restrict the scope of the invention. Several essential features of the invention are revealed through the following examples. Certain features described in one example can be relevant also for the case of another example and/or for the invention in general. The scope of invention is given in the accompanying claims.

### EXAMPLES

In the following examples the measurements are made on a SIPBSC materials exhibiting mechanism 1 (FSMAs, especially Ni—Mn—Ga for numerical calculations) shown in page 6 (namely changes of twin variants) only, but the results can also be achieved on materials in which mechanisms 2 or 3 operate, although those mechanisms are not used in the examples.

The sensor properties can be divided into two areas: use of reluctance change of the piece of an SIPBSC material or use of the electrical resistance change of the piece of the SIPBSC material. Both of these cases have been demonstrated in a linear one dimensional position sensor:
Case 1: Position sensor using reluctance change
Case 2: Position sensor using resistance change

In addition of using the material in a one dimensional linear position sensor it can also be used in two-dimensional sensors, bending sensors or torsion sensors

Beside the simple operation of the position sensor, the operation of the SIPBSC material (twin variant case) is also demonstrated and measured in the following three examples of sensor applications:
Case 3: Joystick
Case 4: Velocity sensor
Case 5: Acceleration sensor

Based on the same principles as in sensor applications it is also possible to generate electric power from the signals coming from the devices based on SIMBSC materials. For this purpose we show one application (Case 6). Those devices can also be used as controllable vibration dampers, e.g., In a time dependent manner. The electric power generated in the device by mechanical vibrations can be converted to other forms of energy or dissipated to heat in a controlled way.
Case 6: Power generation application
Position Sensor Using Reluctance Change (Case 1)

The ferromagnetic shape memory (FSMA) material is a special case of SIPBSC materials. Reorientation of the twin variants by stress or by a magnetic field changes its magnetization curve and shape. Using the change of reluctance of the piece of an FSMA material as a position sensor can be used in many technical ways. We have used both AC and DC magnetic fields to generate the signal. Sensing of the reluctance change has been done with a coil or with the sensor which can sense the magnetic field. The measurement direction has been parallel or orthogonal to the direction of the mechanical motion.

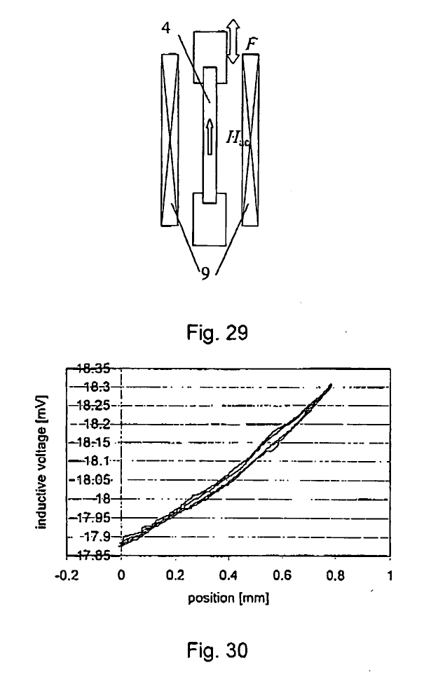

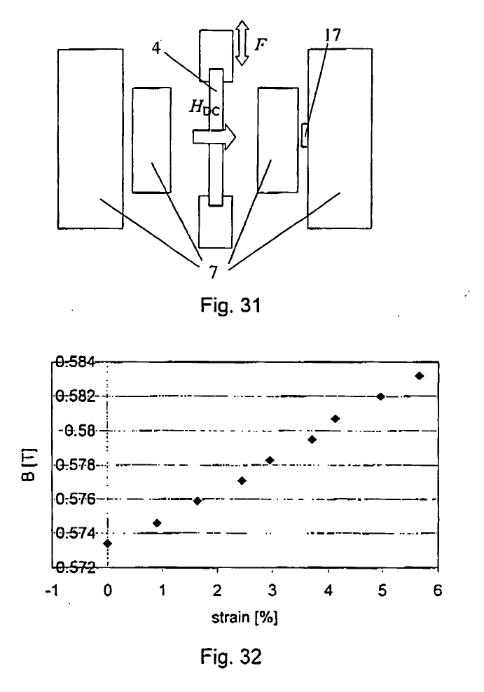

We also show three examples of measurements where the reluctance change can be used for position sensing. In the first example we have used coils to measure the change in AC magnetic field when measuring the change in reluctance in the direction parallel to the mechanical motion. The measurement set-up is shown in FIG. 29, where 4 is the piece of an FSMA and 9 are the coils. The experimental results shown in FIG. 30 reveal a smooth dependence of the inductive voltage on position. In the other example case the change of the magnetic field is measured in the DC magnetic field in the direction orthogonal to the mechanical motion. The measurement set-up of this measurement can be seen in FIG. 31, where 4 is the piece of the FSMA, 7 is the ferromagnetic core and 17 are magnetic field sensors. The results shown in FIG. 32 reveal quite a linear dependence of B on position (strain) although the resolution of the measurement is not very high.

In more detail we show the third example case where we use AC magnetic field to generate signal in the orthogonal direction. Sensing is performed with coils. In this example we measure change in inductance of the magnetic circuit in which the piece of the FSMA is causing the changes. In this case the inductance gives the position information.

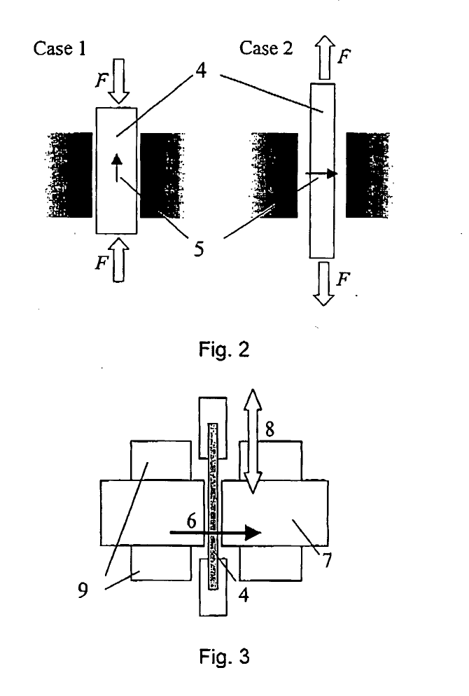

FIG. 2 shows two conditions of the piece of the FSMA, also called FSMA element in the following text, in the air-gap of the inductor, where 4 is FSMA element, 5 is easy magnetization direction. From FIG. 2 we can easily understand that two things generate the change in inductance: namely change in dimensions of the FSMA element and change in permeability of the FSMA element. Also what we can see from FIG. 2 is that these two phenomena are opposite to each other. When the element is long (Case 2 in FIG. 2) the air-gap between the element and the core is large, which decreases inductance, but at the same time the permeability of the FSMA element is large, which increases inductance. The opposite situation happens when the FSMA element is short (Case 1 in FIG. 2).

In all measurements the FSMA element was placed in an air-gap of a ferrite inductor. This can be seen in FIG. 3, where 4 is the FSMA element, 6 is the direction of the permeability measurement. 7 is the ferromagnetic core, 8 is movement direction and 9 are coils. The direction of the permeability measurement affecting the inductance of the material can be seen FIG. 3. The FSMA element was put into the air-gap of the inductor and connected tightly to the tensile testing machine. The force to the sample was slowly changed between tension and stress. During the change of the length of the element the inductance of the inductors was measured. From this we can see the dependencies of length of the element and the stress applied and the change in the inductance of the magnetic circuits.

Position (length of the FSMA element) was measured with a clip-on displacement sensor (resistive measurement). The force was given and measured with Lloyd instruments LRX Plus. The inductance of the inductors was measured with SRS lock-in amplifier. The measures of the inductor can be seen in Table 1.1 The size of studied rectangular sample was 2.1 mm×1.3 mm×10 mm. The peak current in the measurements was iₚₑₐₖ=135 mA.

TABLE 1.1
Measures of the inductor

| | |
|---|---|
| Number of turns | 134 |
| Air-gap length | 1.5 mm |
| Air-gap area | 7 mm × 7 mm |
| Dimensions | 25 mm × 25 mm × 25 mm |
| Core material | Ferrite 3F3 |
| Inductance | 1.4 mH |

Measurements were done in different frequencies of 10-200 Hz of supply voltage. Significant change in curve shapes was not observed with different frequencies.

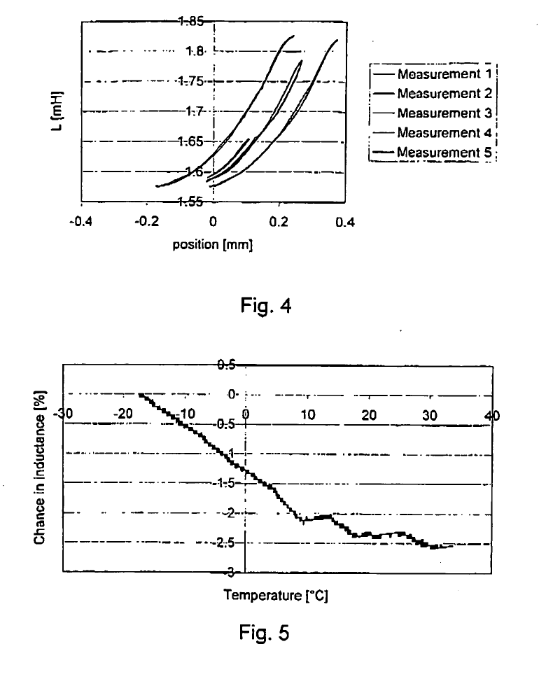

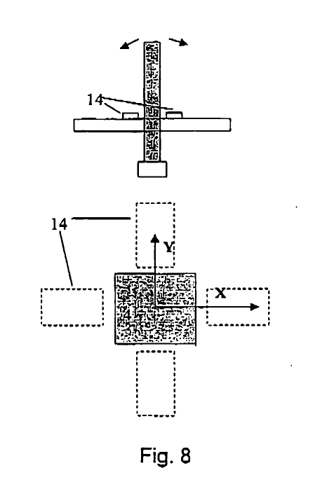

The measured results are shown in FIG. 4. It shows many different measurements, where the zero position of the measurements is different. That's why the curves do not overlap. FIG. 8 shows the rise of inductance, when the FSMA element is getting longer. This is expected, because the permeability of the sample in the measured direction grows when the element elongates. Measurements show also some hysteresis, but it is most likely due to the measurement error.

Temperature affects the permeability of the materials. Temperature dependence was checked with measurements. Temperature of the sample and the whole measurement system was set to −20° C. in the system described in FIG. 3. Then the temperature of the sample was risen naturally and with heat fan. Temperature was measured with thermocouple near the sample. Results are shown in FIG. 5. Change of inductance gradually decreases about 2.5% with increasing temperature from −17° C. to 30° C. The inductance is affected by the change in permeability of the FSMA material as well as the change in permeability of the ferrite. The permeability area in the in temperature region of −20 . . . 30 of the ferrite is from μᵣ=1400 to μᵣ=2000. The effect of this change to the inductance was estimated with the field calculation (FEMM) to be 1.5%. So we can roughly estimate that change in permeability due to change in temperature of the FSMA element causes about 4% change in the inductance.

Position Sensor Using Resistance Change (Case 2)

Electrical resistance of the SIPBSC material element depends on the length of the material. This can also be used to make a position sensor. In this example case we study FSMA, which is a special case of SIPBSC materials. The resistance R of the FSMA element as a function of the strain ε is

$$R = ρ \frac{{I}_{ɛ = D}}{{A}_{ɛ = D}} {( 1 + ɛ )}^{1} \approx ρ \frac{{l}_{ɛ = D}}{{A}_{ɛ = D}} ( 1 + 2 ɛ ) , \qquad ( 1 )$$

where l is the ength and A is the crossection of the FSMA element and ρ is the resistivity of the FSMA element. The formula 1 is a straight line as a function of the strain.

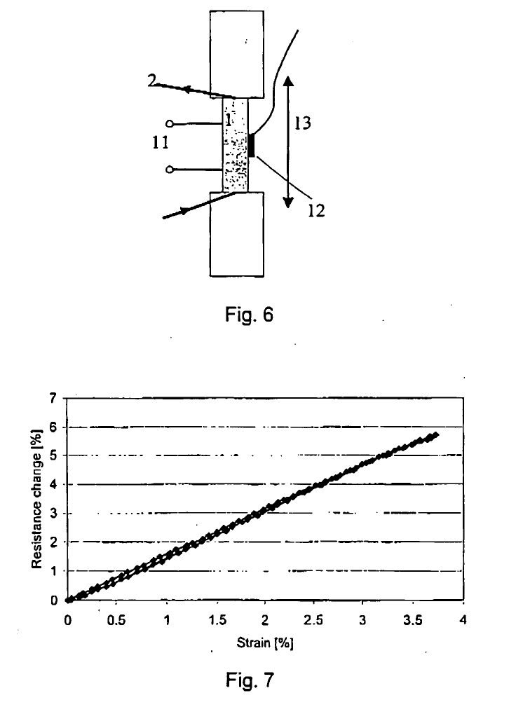

This phenomenon was checked with measurements. FSMA element was connected tightly to the tensile testing machine. The studied sample was rectangular with dimensions 1.5 mm×5.3 mm×30 mm. The length of the FSMA element was changed with tensile testing machine and the resistance was measured with the 4-point measurements. The measurement set-up is shown in FIG. 6, where 4 is the FSMA element, 10 is current l, 11 is measured voltage U. 12 is thermocouple, 13 is the direction of force in tensile testing machine. Resistance is then calculated as

$$R = \frac{U}{I} . \qquad ( 2 )$$

The shape change was measured with laser position sensor. In the measurement the shape of the element was changed. The strain and resistance was measured, The results of the measurement are shown in FIG. 7. The calculated values of resistance differ from measured results. Still the measured resistance depends linearly on the strain as the formula (1) interprets.

Joystick (Case 3)

3.1Introduction

Usage of SIPBSC material as a joystick in this example case is based on the change in permeability. In this case magnetic shape memory (FSMA) sample was studied. In this case when the FSMA stick is bent it causes tension and stress on different sides of the stick. As a result the other side of the stick has high permeability and the other has low permeability. This generates magnetic asymmetry between the opposite sides of the stick. If magnetic field is produced under the stick the asymmetry can be seen with magnetic field sensors around the stick. The joystick can be made two-dimensional (2D) by setting four sensors in two directions around the sample. In FIG. 8 is a schematic view of the system is shown, where joystick 4 is the FSMA element, 14 is the magnetic field sensors.

The 2 D joystick structure could also be built from four separate SIPBSC elements and operating principle could also be resistance change in the material. Similarly one-dimensional (1D) SIPBSC joysick can be built from two separate SIPBSC elements.

Numerous different joystick tests were performed. Two designs of the structures have shown most promising results and were evaluated:
1. The whole stick is made of FSMA material.
2. Only the bending root of the stick is made of FSMA material and the rest is made of rigid nonmagnetic material.
   3.2 Results of the First Solution

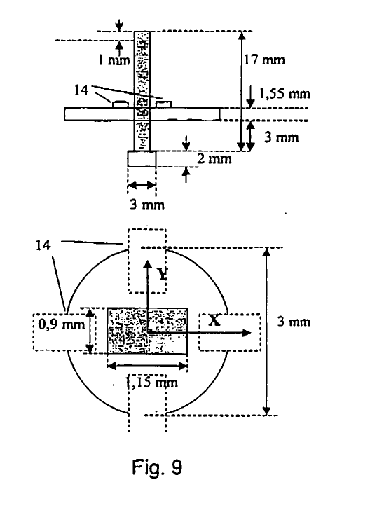

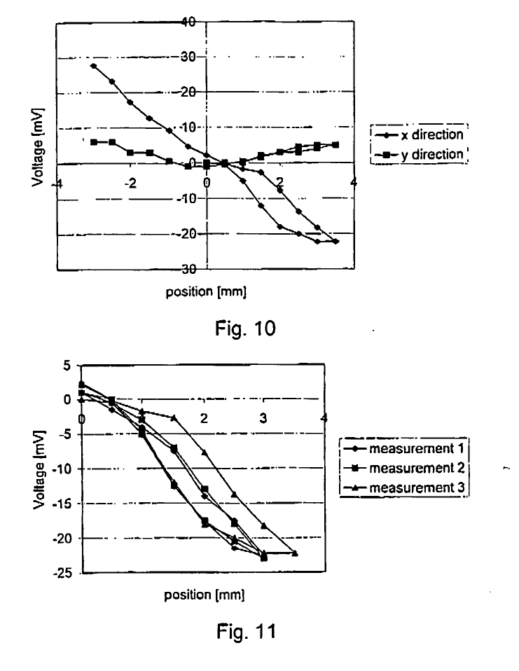

The hysteresis effect was high in the case where whole joystick was of FSMA material. The dimensions of the system can be seen in FIG. 9, where 4 is the FSMA element and 14 are magnetic field sensors. Measured curves are shown in FIG. 10. These show curves measured in x-direction of the material. The position was measured with plastic slide gauge. The magnetic field was measured with four magnetoresistive sensors which were positioned symmetrically around the sample. They were placed in two orthogonal directions x and y.

The hysteresis loop was measured several times and the results are summarized in FIG. 11. Hysteresis loop is mostly due to bending of the long elastic stick. The movement of the stick end does not always effect the conditions in the root of the stick where the sensors are. This results in hysteresis that is not significant. This problem can be removed using a solid end of the stick.

3.3 Results from the Second Solution

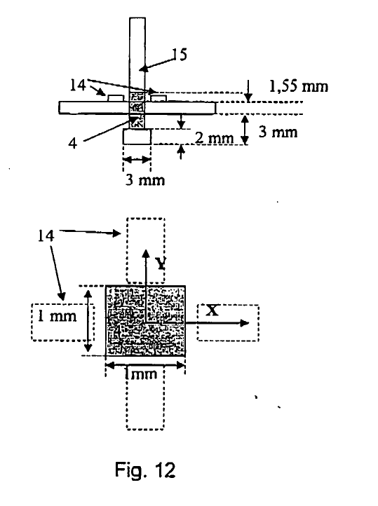

Measurements were done from the joystick solution were the stick was made out of two parts: rigid copper stick and the FSMA element. Magnetic field was measured with magnetic field sensors. Dimensions of the system are shown in FIG. 12, where 4 is the FSMA element. 14 are magnetic field sensors and 15 is a rigid copper stick.

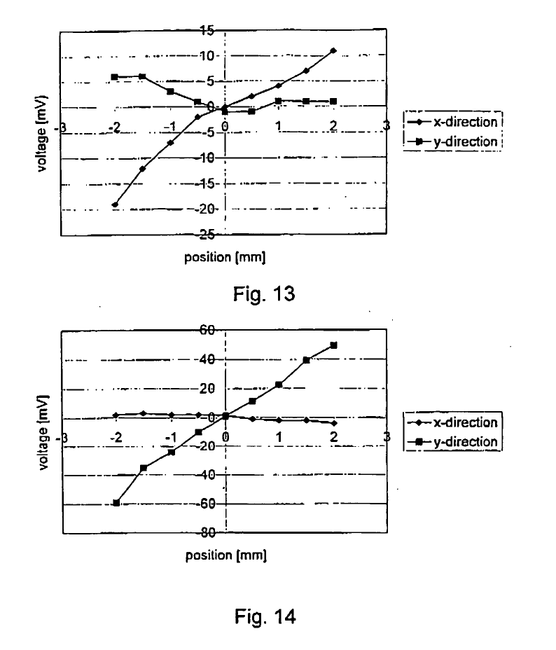

Signal curves from these measurements were also shown in the beginning of this report. Also other sticks were studied in similar conditions. In FIGS. 13 and 14 are the results from one other FSMA stick which had cross-section of 0.7×1 mm, are also summarized. Because the stick was not symmetric the results show a clear signal difference between the two directions. Hysteresis curves are not shown in the Figures. However, in this case the hysteresis was small.

3.4 Explanation of the Behavior of the Joystick

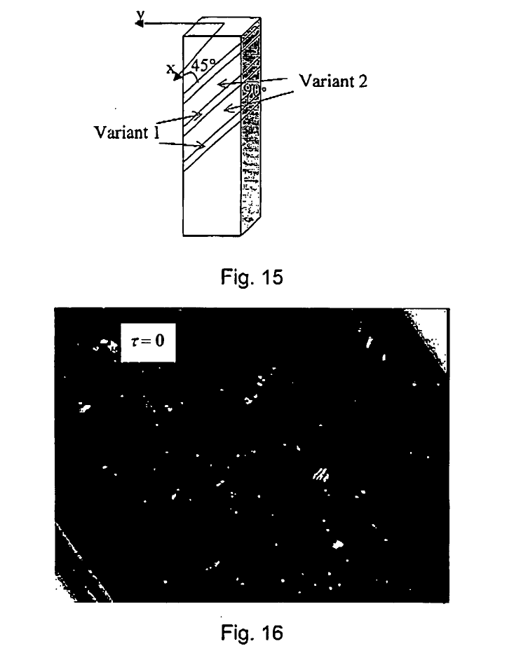

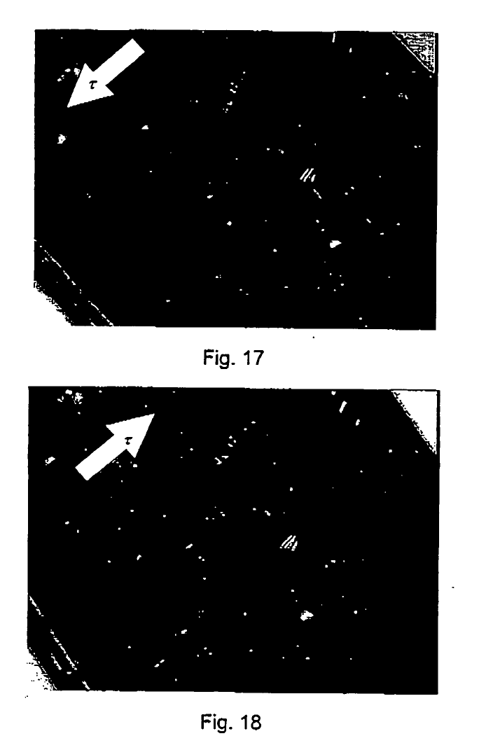

The reason for the observed signal during bending of the FSMA stick can be understood from the material structure. The orientation, proportion and movement of martensite twin variants during bending of the FSMA stick are critical in observing signal output. The martensite twins of the material can be studied with the help of optical microscopy. The stick from the first solution was examined. A schematic representation of the martensite twin variants in the examined stick is given in FIG. 15. Twins are aligned with 45° angle on the plane perpendicular to X-direction, and with 90° angle on the plane perpendicular to Y-direction. Pictures taken under the microscope are presented in FIGS. 16-20. As can be seen, there are two martensite variants in the stick. The variant, which has c axis along the stick, can be seen as lighter area. The darker area is of that variant which has the c axis perpendicular to the stick. From these Figures we see that in stable (not bent) position the lighter area is larger than the darker one. This indicates that magnetic field is relatively strong in this position and that the permeability of the stick is relatively large in upward direction. The c axis is the easy magnetization axis in the martensite structure.

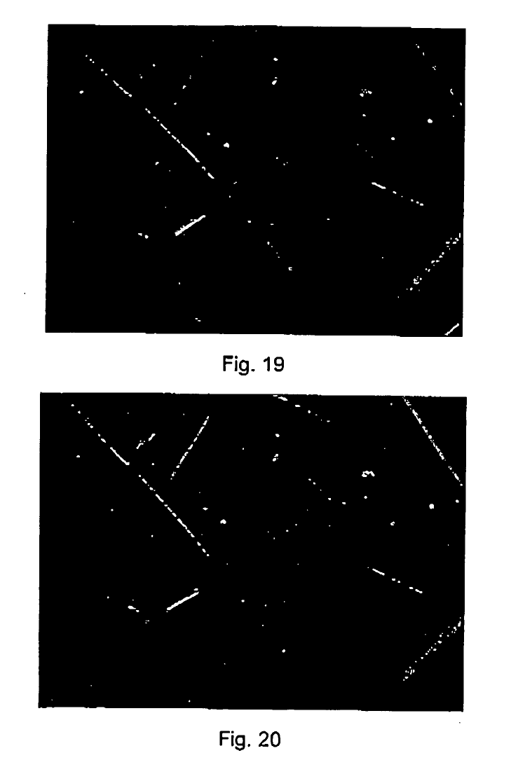

FIGS. 16, 17 and 18 show the behaviour of the material when it is looked at from the positive x-direction and bent in y-direction. The movement of the bends are clear to both y-directions. Similar pictures were achieved from the negative x-direction (FIGS. 19 and 20). The movement of twin boundaries generates signals in the two directions.

Velocity Sensor (Case 4)

If the FSMA material is in a sufficiently high magnetic field, the material can be used as a velocity sensor. One embodiment of a velocity sensor can be, for example, a device shown in FIG. 3 with an added DC magnetic field affecting in the same direction as the coils (electromagnets). In this type of velocity sensing device the speed of the shape change of the FSMA element causes induced voltage to the coils of the device. This is due to the fact that the flux density b in the FSMA material depends on the strain ε of the material. If FSMA element is thin we can assume the relation to be linear

$$b ( h ) = {b}_{1} ( h ) + \frac{ɛ}{{ɛ}_{m , n}} ( {b}_{ij} ( h ) = {b}_{i} ( h ) ) , \qquad ( 3 )$$

where h is magnetic field strength, bₜ(h) is the flux density in the transverse direction, bₛ(h) is the flux density to axial direction, εₘₐₓ is the maximum strain

According to Faraday's law the induced voltage is

$$u = - N \frac{ⅆ ϕ}{ⅆ t} = - NA \frac{ⅆ b}{ⅆ t} \qquad ( 4 )$$

If we assume that the h is constant during the measurement the relation between the induced voltage and the strain becomes

$$u = - N \frac{ⅆ ϕ}{ⅆ t} = - NA \frac{{b}_{m} ( h ) - {b}_{i} ( h )}{{ɛ}_{m , n}} \frac{ⅆ ɛ}{ⅆ t} = - Nw \frac{{b}_{u} ( h ) - {b}_{i} ( h )}{{ɛ}_{m , n}} v , \qquad ( 5 )$$

where the w is the width of the FSMA element and v is the velocity. So the voltage is directly proportional to the speed.
4.1 Measurement Results

Measurements using an example velocity sensor were performed. The FSMA element was put into air-gap of the magnetic circuit. The studied magnetic circuit had permanent magnets to generate DC magnetic field and coils to detect the velocity as induced voltage. Properties of the studied system can be seen in

TABLE 4.1
Measurement system properties

| | |
|---|---|
| Number of turns in coil | 4000 |
| Inductance of the coil | 6.98 H |
| Resistance of the coil | 159 Ω |
| FSMA element size | 5 mm × 0.2 mm × 17 mm |

For the studied velocity sensing device N=4000, w=5 mm, bₛ(h)−bₜ(h)=0.436 T. εₘₐₓ=0.06. When we input these values in the formula (5) we get a result
μ=145·ν

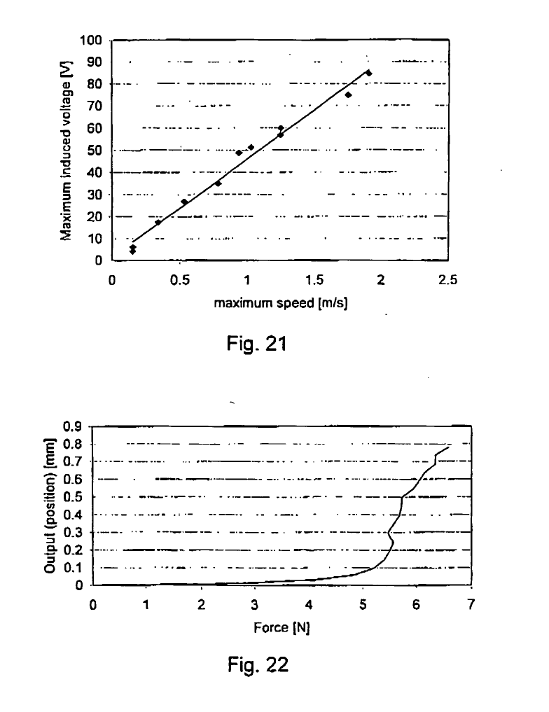

The measurements were done by changing the element size with different velocities and measuring the induced voltage. The results revealing a linear dependence between maximum induced voltage and maximum speed are shown in FIG. 21. The measured induced voltages are considerably lower than calculated ones (Formula (5)). Reason for this are the assumptions made for the formula; most importantly the eddy currents, which are not taken into account. Still the relationship between the induced voltage and the speed is linear as formula (5) predicts. The inaccuracies in the FIG. 5 are due to the error in the speed (velocity) measurement.

Acceleration Sensor (Case 5)

The FSMA material has significant hysteresis in the stress strain curve. This means that the FSMA material will not change its shape until it has been loaded with high enough external stress. The needed external stress is equal to the sum of twinning stress and possible extra stress generated, for example, with a spring load. This can be used to make an FSMA material acceleration sensor. The sensor gives output signal when the dynamic force caused by acceleration rises above the needed threshold force or stress (see σᵣ in FIG. 1b). Then the shape and velocity of the material changes. The shape or velocity change in turn can be measured with different ways shown for example in cases 1-4. This way the material can be used to produce information about the acceleration of the system it is in. The system gives signal when acceleration a is

$$a = \frac{{F}_{three}}{m} , \qquad ( 6 )$$

where the Fₜₕᵣₑₑ is the threshold force and the m is the moving mass.

FIG. 22 shows a measured example of a stress-strain curve for the FSMA element, which reveals the explained phenomena. The measurement was performed with a Lloyd instruments LRX Plus tensile testing machine. In this case the threshold force is 5N. The material shape does not change much in the case when the force acting on the FSMA element is smaller than 5N. When the force rises above 5 N the element starts to move and gives high signal output. Elements made from an SIPBSC material like alloy B in FIG. 1b, in which material the shape change of the element can be even up to 17% when the threshold stress is exceeded, are very suitable for acceleration sensors, too.

In detecting the acceleration both magnetic parameters (such as permeability, magnetization or reluctance) or electrical resistance can be used. When coils are used in detecting magnetic parameters, they can be placed as solenoids around the element (like in FIG. 29) or in the way shown in FIG. 3.

Power Generation Application (Case 6)

6.1 Theoretical Background

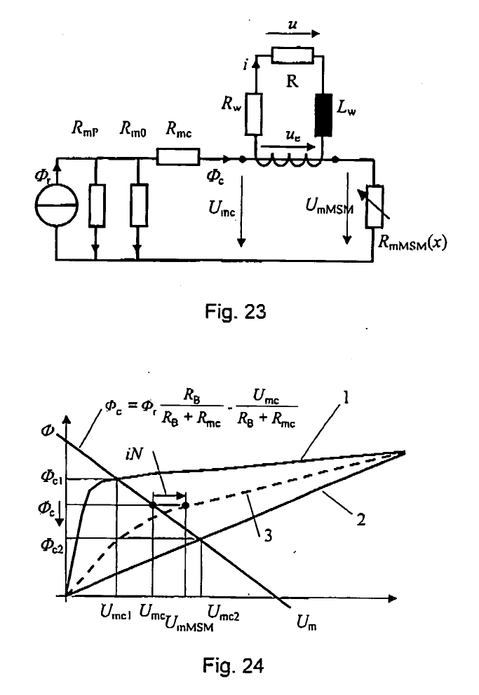

Mechanical energy can be converted to the electric energy in a device in which the SIPBSC element is deformed. Feasibility of this operation is proved using an equivalent circuit diagram. For this purpose, a device with a permanent magnet (PM) for biasing is presented by the simplified equivalent electric and magnetic circuit given in FIG. 23.

In FIG. 23, φ₁ represents the remanence flux of PM, R_{mPM}−the magnetic reluctance of the PM-body, R_{mO}−magnetic reluctance of the biasing air-gap, R_{mc}−the magnetic reluctance of the core and R_{mFSMA}(x)−magnetic reluctance of the FSMA stick at the stroke x. Saturation effect of the magnetic circuit is neglected, because the device should be designed for the normal operation without saturation.

By applying the outer force, the stroke of the FSMA stick changes and R_{mFSMA}(x) changes as well. Therefore, the core flux φ_{c} changes and induces the voltage u [symbol] in the winding that is placed around the core. As a result, the current i flows in the circuit, if the winding with electric resistance R_{w} and inductance L_{w} is connected to load resistance R. Instant value of induced voltage u is defined by a simple differential equation:

$${u}_{e} = N \frac{ⅆ {Φ}_{c}}{ⅆ t} . \qquad ( 7 )$$

where n is the turn number of the winding and t is time.

It follows from the equivalent circuit that the core flux φ_{c} and magnetic voltage U_{mac} are dependent on each other:

$${Φ}_{c} = {Φ}_{r} \frac{{R}_{u}}{{R}_{0} + {R}_{mc}} - \frac{{U}_{mn}}{{R}_{β} + {R}_{mc}} , \\ or \\ {U}_{mc} = {Φ}_{c} {R}_{tt} - {Φ}_{c} ( {R}_{β} + {R}_{mc} ) \\ where {R}_{β} = \frac{{R}_{mPM} \cdot {R}_{mD}}{{R}_{mPM} + {R}_{m0}} . \qquad ( 8 )$$

Based on Kirchhoff's low for magnetic circuit, we can write:
U_{mc}=iN+U_{mMSM} (9)
where N is the number of the turns of the winding.

Equations 7, 8 and 9 are presented graphically in FIG. 24 at descending φ_{c} (dφ_{c}ldt<0), where curve 1 corresponds to an area (of the piece of material) of easy magnetization when the length of the piece is x=xₘₐₓ curve 2 corresponds to the area of hard magnetization when x=xₘᵢₙ and curve 3 is an actual magnetization curve when the length of the stick is x (xₘᵢₙ<x<xₘₐₓ).

Let us start from the initial point (U_{c1}, φ_{c1}) that corresponds to the totally expanded FSMA stick. At this stick attitude, permeability of the piece of the FSMA material has maximum value and the magnetic reluctance R_{mFSMA} has minimum value. In this case we have the magnetization curve along the easy axis. When we apply the compression force, the stick compresses, the magnetic properties of the piece of the FSMA material change and we have the actual magnetization curve given by the dashed line in FIG. 24 (permeability reduces and magnetic reluctance increases). Therefore, φ_{c} reduces and induces the voltage u_{c} in a winding. Voltage u_{c} creates the current i, that tries to prevent flux reduction. As a result, the magnetomotive force iN appears and the operating point of the piece of the FSMA material shifts to the right from the straight line given by Equation 8, Operating point moves until point (U_{c2},φ_{c2}), at which we have the magnetisation curve that corresponds to the hard axis. The corresponding path of the operation point is given in FIG. 24. The stick is compressed totally in the point (U_{c2},φ_{c2}) and has minimum permeability. Therefore, magnetic reluctance R_{mFSMA} has a maximum value and at the same time the magnetic flux φ_{c} has a minimum value. When we start to expand the stick, the value of magnetic flux φ_{c} increases and process goes in the opposite direction. The operating point shifts to the left from the straight line given by Equation 8 and we come back to the initial point (U_{c1}, φ_{c1}).

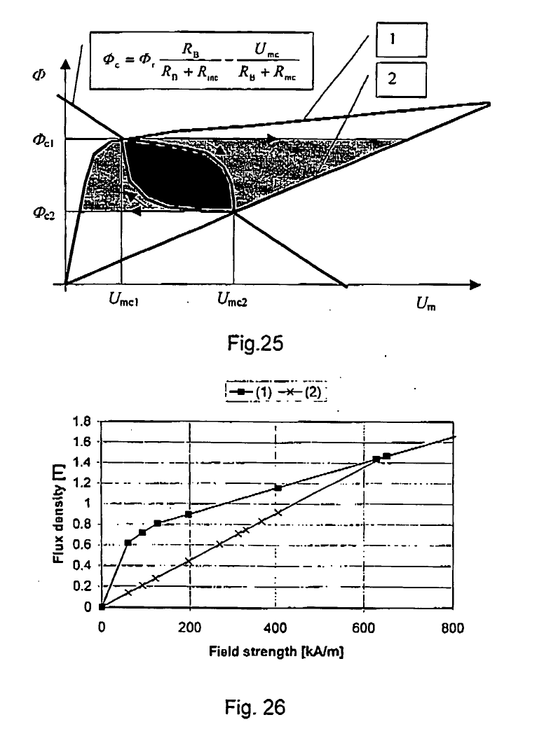

FIG. 25 shows the descending and increasing branches of the operating point trace. In FIG. 25 curve 1 corresponds to an area (of the piece of material) of easy magnetization when the length of the piece is x=xₘₐₓ and curve 2 corresponds to the area of hard magnetization when x=xₘᵢₙ.

Instant electric power p_{c} induced in a winding by magnetic field is determined from Equations 7 and 8 as

$${p}_{e} = {u}_{q} l = ( {U}_{mc} - {U}_{mMSM} ) \frac{ⅆ {Φ}_{c}}{ⅆ t} , \qquad ( 10 )$$

The value of the electric energy W_{c} transferred into electric circuit of the winding during one cycle follows from Equation 10.

$$\begin{matrix}{W}_{e} = {\int }_{0}^{T} {p}_{e} ⅆ t = - ∮ {U}_{mMSM} ⅆ {Φ}_{c} \\ = - {\int }_{{v}_{MSM}}^{} ( ∮ {H}_{MSM} ⅆ {B}_{MSM} ) ⅆ {V}_{MSM} .\end{matrix} \qquad ( 11 )$$

where T is cycle period, V_{FSMA}. H_{FSMA}, B_{FSMA}−volume, magnetic field strength and flux density of the FSMA stick.

Therefore, the dashed area between the branches corresponds to the electric energy W_{c} transferred into electric circuit of the winding during one cycle. As we see, this energy is produced by a mechanical motion of the FSMA stick (compression and expansion). The grid area in FIG. 25 determines theoretical maximum possible value of W_{c}.

Based on Equation 12, the average electric power P [symbol] produced by the FSMA stick

$${P}_{MSM} = {p}_{eav} {V}_{MSM} = \frac{{V}_{MSM}}{T} ∮ {H}_{MSM} ⅆ {B}_{MSM} = \frac{{V}_{MSM}}{T} {w}_{eMSM} \qquad ( 12 )$$

where ρ [symbol] and w_{cFSMA} are the specific average electric power and magnetic cycle energy of the FSMA material.

The value of W_{FSMA} and ρₐᵥ are computed:

$${w}_{eMSM} = ∮ {H}_{MSM} ⅆ {B}_{MSM} ; \\ {p}_{eav} = \frac{1}{T} {w}_{eMSM} = {fw}_{eMSM} \qquad ( 13 )$$

where f=1/T is the cycle frequency.

Equations 12 and 13 are basic expressions for the assessment of the power generation feasibility of FSMA devices. They show that for the maximum power, the operating point of FSMA material has to be chosen in region with maximum cycle energy.

Above given analysis is made on assumption that we generate electric energy and permanent magnets are available. It is no difficult to prove that same consequences can be obtained when permanent magnets are missing or we convert electric energy into mechanical energy. Main differences are in a mode how we choose and design the operation region of FSMA material.

6.2 Experimental Results

As an example, the magnetisation curves of one FSMA material are given in FIG. 26.

Limit value of magnetic cycle energy w_{eFSMAm} is determined by the area between easy and hard magnetic axis (anisotropic energy). Numeric integration gives the result

$${w}_{eMSMlim} = {∮}_{D = 1.3 T} {H}_{MSM} ⅆ {B}_{MSM} = 186 k J \text{/} {m}^{3} .$$

If we assume, for example, frequency f=50 Hz. then the limit average electric power density of FSMA-material ρ [symbol] according to the Equation 13 has value
ρ ƒ =50·186·10³=9300·10³ W/m³=9300 kW/m³.

Because FSMA material has the mass density γ_{FSMA}=8000 kg/m³, the limit power mass density is 1.16 kW/kg at 50 Hz. In real devices, depending on application, only part of limit cycle energy could be used (FIG. 25). Part of electric energy also dissipates in winding resistance and in magnetic circuit (eddy current and hystersis losses). Therefore, electric power density is lower in reality.

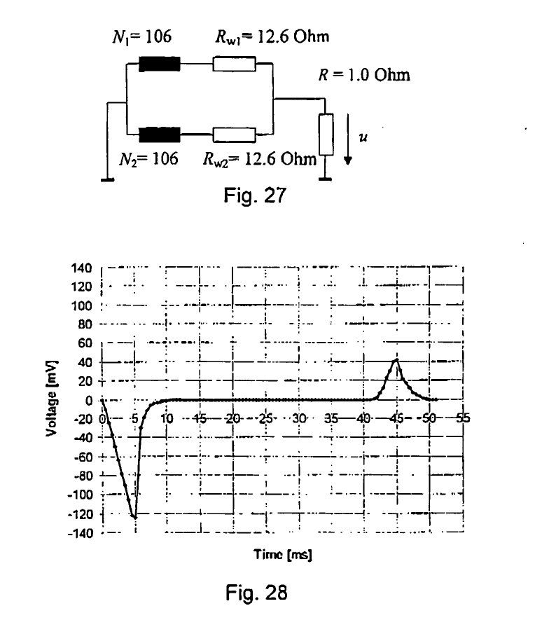

For the demonstration of electric power generation, the test is made according to the diagram in FIG. 27. The device used in the test has PM biasing. The winding of the device has two parallel branches. Each branch has 106 turns and resistance of 12.6 Ohm. The terminal voltage has been measured at load resistance R=1.0 Ohm and this transient is presented in FIG. 28. During the transient, the stick is compressed totally by outer force and after that it expands freely due the bias field.

FSMA stick has the volume of 80 mm³. Based on the transient voltage, the computed specific energy cycle w_{eFSMA}=3.6 kJ/m³ and the difference between maximum and minimum flux densities (flux density swing) is about 0.15 T. Therefore, the received result is only 2% of theoretical limit value. Additional reason for low value is relatively big air gap (0.2 mm) between FSMA stick (thickness 0.5 mm) and magnetic core as well as a solid magnetic circuit of the test device. The resistance of the winding also influences the value of the cycle

As conclusion, we can state that the experimental measurements prove the possibility to generate the electric power by FSMA devices. This means that an electromechanical energy conversion of FSMA devices is reversible.

1. A method for sensing electrical of magnetic and the like parameters, and for utilizing same, comprising:
taking a piece of material with stress-influenced parameters based on structural changes;
directing on the piece of material forces which effect a shape change thereon;
measuring a change in magnetic, electrical or like parameters of the piece of material; and
using the measured parameters for controlling further operations.

2. A method according to claim 1, wherein the forces directed on the piece of material are aimed for deforming the material by pressing, elongating, bending or torsion or a combination of two or more of these operations.

3. A method according to claim 1, wherein the forces are effected by mechanical operation or a magnetic field.

4. A method according to claim 1, wherein the material is used as a sensor for sensing position, velocity, acceleration or like properties.

5. A method according to claim 1, wherein the material is used for energy production.

6. A method according to claim 5, wherein the material is used for controllable damping purposes, e.g. in a time dependent manner.

7. A method according to claim 1, wherein the material exhibits a twinned substructure comprising at least two twin variants or two magnetically different phases.

8. A method according to claim 1, wherein the piece of material is constructed of a ferromagnetic shape memory alloy (FSMA).

9. A method according to claim 1, wherein the piece of material is composed mainly of Heusler alloy, e.g. a Ni—Ma—Ga based material.

10. A method according to claim 1, wherein the piece of material is composed mainly of a Co—Ni based material.

11. A method according to claim 1, wherein deforming the piece of material causes magnetically different phases comprising austenite and martensite.

12. A method according to claim 1, further comprising monitoring electrical properties of the piece of material, including electrical resistance or magnetic properties of the piece of material, including magnetization, permeability and/or reluctance of the piece of the material.

13. An apparatus for sensing electrical, magnetic and like properties of material, and for utilizing same, comprising:
a piece of material with stress-influenced parameters based on structural changes;
a device for directing on said piece of material forces which effect a shape change on said piece of material;
a device for measuring changes in magnetic, electrical or like properties of said piece of material; and
a device for using said properties for further operations.

14. An apparatus according to claim 13, wherein said piece of material exhibits a twinned substructure comprising at least two twin variants or two magnetically different phases.

15. An apparatus according to claim 13, wherein said piece or material is constructed of a ferromagnetic shape memory alloy (FSMA).

16. An apparatus according to claim 14, wherein deforming said piece of material causes magnetically different phases comprising austenite and martensite.

17. An apparatus according to claim 13, wherein said apparatus is a sensor for sensing position, velocity, acceleration or like properties.

18. An apparatus according to claim 13, wherein said apparatus is a joy stick.

19. An apparatus according to claim 13, wherein said apparatus is a sensor monitoring acceleration in air bag applications.

20. An apparatus according to claim 13, wherein the said apparatus generates electric energy caused by deforming of said piece of material.

21. An apparatus according to claim 20, comprising a device for controllable utilization of the energy for damping purposes of said piece of material.

22. An apparatus according to claim 13, comprising a device to control vibration in machines, engines, constructions, vehicles or aircrafts.

23. An apparatus according to claim 13, wherein said piece of material is composed mainly of Heusler alloy, e.g. a Ni—Ma—Ga based material.

24. An apparatus according to claim 13, wherein said piece of material is composed mainly of a Co—Ni based material.

25. An apparatus according to claim 17, wherein said apparatus is a sensor monitoring acceleration in air bag applications.
